(19) United States
(12) Patent Application Publication
(10) Pub. No.: US 2005/0069851 A1
(43) Pub. Date: Mar. 31, 2005

(54) Work place communication, education and implementation system

(76) Inventor: Terrance Monroe Pierce, Idaho Falls, ID (US)

Correspondence Address: Mr. Terrance Monroe Pierce, 4242 W. 49 South, Idaho Falls, ID, 83402, US

(21) Appl. No.: 10/671,018

(22) Filed: Sep. 25, 2003

(51) Int. Cl. G09B 19/00

(52) U.S. Cl. 434/219

(57) ABSTRACT

A system that integrates workplace communication, education, cultural acceptance, and improve the percentage of employees that willfully implement new and/or existing directives.

### STATEMENT REGARDING FEDERALLY SPONSORED RESEARCH OR DEVELOPMENT

The Workplace Communication, Education and Implementation System was made with Government support under Contract No. DE-AC07-99ID13727 awarded by the U.S. Department of Energy. The Government has certain rights in this invention.

### CROSS-REFERENCE TO RELATED APPLICATIONS

Cross-references to other related patent applications that may be appropriate are as follows:

| Patent No. (if | | | |
|---|---|---|---|
| issued) or Patent | Date of Patent or | | |
| Application No. | Date of Application | Inventor | Class |
| 6082500 | Jul. 4, 2000 | Amo, Stephen D. | 187/391 |
| 20020101 | Aug. 1, 2002 | Berque, David | 345/751 |
| 20030084599 | Nov. 5, 2001 | Elul, Rafael | 40/455 |

### REFERENCE TO SEQUENCE LISTING, A TABLE, OR A COMPUTER PROGRAM LISTING

Not Applicable.

### BACKGROUND OF THE INVENTION

Current conventional methods for implementing requirements and other information critical to employers and employees are not always adequate. Employees may or may not physically receive the information and may not willfully translate the information into their personal knowledge and into ongoing implementing behavior. Within industry, there are generally accepted causes for an employee not willfully adopting the information and converting it into the desired behavior. One cause is employee perceptions that contribute to the employee's personal justification not to implement the directive. These perceptions include but are not limited to the following: the employee believes it takes too much effort to sort through the volume of information received and to filter and identify the important information, or to carefully read or otherwise receive the information and then to digest it; the employee believes he or she does not have sufficient time to study, understand, and/or retain the information; the information is written in a style and manner that is difficult for the employee to understand, or in a manner that the employee interprets as not personally relevant; the employee does not agree with the requirement and will not comply except when those responsible for enforcing compliance are watching; the employee perceives that the effort to comply is much greater than the consequences of not complying; or the employee does not understand how noncompliance will adversely affect him or her personally.

Management in the workplace has developed a plethora of conventional, and costly, communication, education, and implementation tools for the purpose of implementing standards, requirements, procedures, directives, policies, goals, objectives, and similar needs. Information is conveyed by electronic mail, films, posters, memoranda, meetings, and one-on-one and group training, to name just a few. The human factors of implementation are generally addressed through positive and negative reinforcement (e.g., rewards, disciplinary actions). However, employees' personal behavior often falls short of full implementation, resulting in adverse effects to the employee, his or her co-workers, their families, and the employer. Adverse effects include, but are not limited to, an increased risk of accidents and injuries, decreased quality, unethical and illegal activities, adverse effects to the environment, decreased profitability, decreased productivity, decreased customer satisfaction, excessive fines and penalties, and an increased cost of doing business. One example of the noncompliance phenomenon and the consequent adverse effects is seat belt usage. According to the National Highway Transportation Safety Administration, after 30 years and billions of dollars of government, employer, and insurance industry attempts to achieve full compliance, 21 percent of people in the U.S. still do not wear seat belts (NHTSA 39-03, Aug. 25, 2003, http://www.nhtsa.dot.gov/nhtsa/announce/press/pressdisplay.cfm?year=2003&filename=pr39-03.html). Lack of compliance with seat belt laws is the primary cause of more than 40,000 deaths per year in the United States. While not all employee noncompliance leads to injury or death, the economic, social, and other costs affect all employers, greatly diminishing the Gross National Product.

### BRIEF SUMMARY OF THE INVENTION

The invention that is claimed is a formulated, systematic process comprising multiple elements that, when used in a specific order and fashion, improves communication, education, cultural acceptance, and implementation of new and/or existing directions at workplaces.

The invention reduces the number and/or percentage of employees whose behavior is not compliant with a given requirement, reducing adverse affects to the employees, the employees' families, and the employer.

The invention addresses barriers to full implementation, such as the following example problem statements:
a. It takes too much effort to read or otherwise receive the information. Solution:

Filter and condense the information to find the nugget of value and place the information release where it is most convenient for the employee.
b. I don't have time to study and/or understand the information. Solution:

Display the information release in a condensed format where the employee has idle and personal time and/or is bored.
c. The information is hard to understand. Solution: Design the information release using language and a format that is both easily understandable to the reader and enhances retention.
d. I don't agree with the requirement; I will only comply when I am being observed by the enforcers. Solution: Publish articles in the information release that clearly point out how the individual is responsible for compliance and how the individual will suffer the consequences of noncompliance, not the enforcers.
e. The effort to comply is greater than the penalty not to comply. Solution: Publish employee norms and taboos demonstrating how the behavior of noncompliant employees adversely affects compliant employees, their co-workers, and their families, as well as the company. Informing all stakeholders of the social norms of compliance serves to bring informal social pressure on the employee to comply.
f. I don't understand how noncompliance will hurt me personally or professionally. Solution: Use the information release to point out the personal consequences of noncompliance.

The invention utilizes a designed dissemination process to provide information to employees at numerous physical locations throughout the workday. The target locations are usually not their workstations, but rather at locations where the employee has nothing else or nothing better to do at that point during their normal workday than to absorb the information and study it repeatedly. The target locations are typically those locations designated within the workplace where employees experience idle, personal time and, thus, are temporarily free from other forms of competing media or distractions and where the learning and understanding of the information release content is maximized and appreciated.

The invention provides an information-transfer process that utilizes a presentation format, tone, and style perceived by the employee as popular and desirable to view and/or hear. The information also may be shared with those people who are important in the personal lives of t h e employee and influence the employee most, such as co-workers and families. The invention is designed to further enhance implementation when information is shared with family and co-workers by exerting further social pressure to increase compliance. Providing the employees' families with knowledge and education on the information to be implemented engages the family as part of the social pressure supporting employee compliance. An additional advantage of the invention is that it allows the family to benefit from information that is applicable to the home and personal time, as well as the workplace.

The invention, by building on and combining individual proven blocks, effectively overcomes the obstacles of implementation by providing solutions to the problems that pose barriers. Use of the invention improves the percentage of employees that:
a. Physically receive each message of information transfer.
b. Voluntarily take the initiative to absorb the knowledge from the information-transfer media for the purpose of decoding it, with intent to fully comprehend its meaning and incorporate it into personal knowledge and proactive implementation.
c. Comprehend the information and understand the expectations.
d. Increase their trust in the information, the information-transfer media, and the information source
e. Gain and maintain ownership of the implementing actions.
f. Study the information until they understand it and retain it for recall.
g. View the information as applicable to them personally.
h. Learn the workgroup and workplace social norms of compliance and taboos of noncompliance.
i. Impose workforce and family social pressures to improve compliance and deter noncompliance.
j. Achieve social recognition and rewards for achievement of goals and objectives of implementation.
k. Adopt personal behavior in compliance with the information and, once it has been achieved, maintain the desired level of compliance and implementation.

### BRIEF DESCRIPTION OF THE SEVERAL VIEWS OF THE DRAWING

Not applicable.

### DETAILED DESCRIPTION OF THE INVENTION

The invention improves the current communication, education, and implementation of beneficial and required information through a formulated system of periodic releases of information applicable to employees on the job and/or their families at their place of residence. This formulated communication process is designed to provide the employee with information designed to educate them and effectively convince a rational person that their personal implementation of the information is prudent and paramount to the employee, their family, their co-workers, and their place of employment.

The workplace is driven by three primary sources of information that provide direction and or prudent information for implementation:
a. Laws and regulations that impose direction from external entities, including federal, state, and local governments and agencies.
b. Direction imposed by internal management.
c. Knowledge from Lessons Learned that represent good practices and success stories to be repeated and/or unwanted acts, conditions, events, and experiences to be avoided. The sources of this information can be drawn from internal sources or from external sources such as related professions and/or industries.

Collectively, these three sources of directional information represent a vital element of the total set of workplace knowledge. A portion of the information transfer process will be made through formal implementation methods, while the remainder will be transferred for the employees' benefit using less formal implementation methods.

Failure to adequately implement applicable directive information within the organization is directly related, but not limited to: (1) targeted individuals who are uninformed or under-informed of the information, (2) targeted individuals who are informed but do not behave in compliance with the information for a variety of personal reasons, and/or (3) targeted individuals who are not physically and/or mentally capable of compliance with the information. The Workplace Communication, Education, and Implementation System addresses the first two reasons for noncompliance.

The claimed invention supplements and improves on current, conventional implementation tools to improve compliance. This invention can be used to supplement traditional, formal and informal implementation systems (a) in advance of those other methods, (b) concurrently with or parallel to those other methods, or (c) after the other implementation methods. In addition, the invention can be used in place of traditional implementation systems, in which case the company can realize significant cost savings in addition to the savings they will achieve from avoidance of unwanted behaviors. In all uses, this invention improves the information-transfer of what is currently under-implemented information.

Ultimately, successful implementation in the workplace depends on whether knowledge-holders can successfully transfer the necessary information to employees in a manner that fully informs the employees who then decode the information, comprehend its text and subtext, transform the information into willful personal behavior that fully implements the directive, and continues implementation long after the original information-transfer takes place.

The invention achieves this desired state of implementation by identifying the real and perceived obstacles to implementation and overcoming those obstacles through a series of information releases to the employee that effectively convinces the employee to comply. For example, if the barrier is that the employee does not receive the information, or have time to read the information, or have time to study the information to optimize retention, then the periodic information release is placed where the employee has idle and/or personal time and will see and/or hear it without distraction or competition from other media. Because employees frequently do not like or trust formal, top-down directive information, the release content is designed to be horizontal or bottom-up communication, and is mixed with other information in a release that is popular with the employees. Because employees frequently do not understand the top-down directives, the format and style is carefully designed to use the employee's language (“street” or everyday language). Because employees frequently do not consider directives to be personally applicable, the information release is designed to use a series of articles to educate the employees on applicability until they take ownership, and the design includes stories from co-workers or other trusted sources, to build trust in the individual directive as well as directives as a whole. Because employees frequently do not trust the source of the information or directive and defy compliance, the information release is designed to use a series of stories from neutral and trusted sources.

The foundation of this invention is the periodic release of information through physical display of the information where it is conveniently provided for the employee to see and/or hear the information during their normal workday. The targeted display locations are carefully selected, normally at locations well away from the employees' workstations so that other forms of competing media (i.e., telephones, computers, written material, co-workers, meetings, or work itself) are reduced or nonexistent. These locations are where the employee is expected to experience idle, personal, and/or non-productive time. At these locations, employees experience moments in the workday when they are not distracted and are temporarily bored; thus, the invention enhances their receptivity to receiving the information provided.

The invention is designed to use unique advances in information design such that the information-transfer is optimized. The presentation of the information is carefully designed to be popular with employees. Target locations for the information-transfer process are selected within the workplace such that employees will have the opportunity to repeatedly absorb the information throughout their normal workday. At these locations, typical employees are in a state of temporary boredom or idleness and highly receptive to learning.

Pilot studies of the invention and follow-up surveys confirm that virtually all employees receive the information-transfer repetitively; understand the information; perceive the information as popular and welcome; enjoy and ask for the information release; and trust its content. This allows the invention to be an improved process of communication, education, and implementation of important information.

While the formal and informal information for implementation are contained within the same information release, the formally implemented information is addressed in a prescribed formula that determines the information sequencing. The formulated information releases serve to overcome barriers to implementation and achieve the desired result of employees who willingly implement the requirement and encourage coworkers to do the same.

The ultimate goal of the information release and formulated approach is to increase the percentage of employees who comply and decrease the percentage who would otherwise not comply.

The information media used to disseminate the information at the specified physical locations throughout the work place includes any and all available forms of media capable of displaying the complete information release visually and/or audibly within the workplace and/or place of residence.

The employees at work and employee families are receptive to the information because the format and tone of delivery is popular with the information receiver and the employee “doesn't have anything better to do” at idle-time locations. The pleasing and popular format and style is accomplished by not taking the traditional, top-down order or formal command approach to communication; rather the information is presented horizontally peer-to-peer and/or a bottom-up flow of communication. Additionally, the information popularity is achieved by striving to achieve the following: easy reading and fun; first person personal; informal; peer to peer without implication of hierarchy; friends sharing beneficial testimonial information and endorsing compliance; entertaining; informative; striking a spectrum of emotions, including joy, grief, thankfulness and physical displays of emotion including tears and laughter. Within this popular information release is imbedded the important information for implementation and compliance.

The amount of information provided in any one article within any one information release is edited to correspond with the amount of time the employee is expected to be idle at the information delivery location. While the size and amount of information can vary, the time to read an article is typically under 60 seconds of broadcast time and/or up to two pages of 8½×11 inches, or approximately 350 words, combined with pictures or other graphics.

The physical location of the transfer media within the idle time location is strategically placed to match the expected physical position of the employee's face during the idle time. That is if the employee's idle time was expected to occur at an elevator, or copy machine, or urinal the employee would be expected to be standing and the transfer media location would be positioned on the wall at approximate face height. Correspondingly, if the idle time location were expected to occur at a lunchroom or in a toilet stall, the transfer media would be located low on the wall or on the table near to face height.

The frequency of information releases to the employees is determined by the frequency with which employees actually receive the knowledge to achieve the desired level of understanding and retention. Typically, each employee receives the information repetitively each day, achieving the desired levels of understanding and retention within three to five working days or one working week. Thus, the periodic information release is provided continuously for more or less one week and changed to a different edition. The number of periodic releases that address any one directive to be implemented is determined by the amount of time needed for the workforce to achieve compliance.

### DETAILS OF THE INVENTION

The following is a hypothetical application of the invention of claim as applied to implementing the use of seatbelts while driving company-owned motor vehicles on the job. However, the practice of using seat belts is best adopted for the use of both company-owned and privately owned vehicles. Thus, the information is also provided at the employees' place of residence for their benefit and their application of family unit pressure on the employee to achieve compliance. The illustration assumes a weekly release of information posted in the idle and personal time locations for all employees to view on the job and/or their place of residence. The hypothetical illustration is in keeping with the descriptions set forth to describe the invention above. Note each popular weekly release contains several other short stories addressing other subjects for formal and informal implementation and casual information of popularity and benefit to the reader at work and at home. The following hypothetical illustration addresses only the subset of the publication that addresses information for formal implementation.
a. Week 1: “Shock” Introduction. Provide a headline short story that addresses the shocking details and fatal consequences of an employee or peer that the employee can relate to that did not wear a seat belt while driving. The story should emphasize the loss/price(s) paid by families, friends, and co-workers.
b. Week 2: Success story. Provide an employee success story highlighting how an employee or industrial peer was involved in a severe accident and lived to tell the story because he/she wore a seatbelt.
c. Week 3: Ask the question. Pose a question to the work force, “Do we have a seat belt problem in our work force?” Additionally, provide another story that details the tragic consequences of not wearing a seat belt.
d. Week 4: Give the answer. Provide highlights of the stakeholders' responses to question posed in Week 3, above. Additionally, provide answers to the questions from a technical expert's point of view. Use statistics and factual technical information that support the magnitude of the problem and the need to resolve the problem at the work place to support the story. Additionally, provide another story that stresses the benefits of wearing a seat belt.
e. Week 5: Keep score. Provide a scorecard of performance showing beginning score, current score, and the goal. Also list the performance of each organizational entity within the company. Additionally, provide another true story that details the tragic consequences of not wearing a seatbelt.

f. Week 6: Personalize the problem. Provide a story that outlines the many losses of the employees and/or families due to automobile accidents. Identify local, state, and national statistics that support the use of seatbelts. Publish the performance measure results identifying implementation progress including start point, current point and end goal; name of the organization that is the most compliant; and name the organization least compliant. Additionally, provide another story that stresses the benefits of wearing a seat belt

g. Week 7: Establish ownership. Provide a story that points out that the problem is the individual employee's problem to resolve. Point out that the individual is the only one who can buckle up for him or herself. It is not the workforce's problem or a safety professional's or management's responsibility, it is each individual human's responsibility for his or her own behavior to arrive home at night safe and uninjured. Publish the performance measure results identifying implementation progress including start point, current point, and end point, the name of the organization that is the most compliant, and the name of the organization that is least compliant. Provide another story that details the tragic consequences of not wearing a seat belt. Additionally, solicit stories and dialogue on the acceptable workplace norm culture toward driving safety and seatbelts.

h. Week 8: Establish the workforce norm. First, provide the results of the employees' comments on acceptable behavior and emphasize the unacceptable view of the work force against those who choose not to comply with the workforce norm. Second, publish any challenging views, followed by any employee and/or editorial rebuttal. Third, provide a story that solicits the employees' suggested solutions to the seat belt problem. Fourth, publish the performance measure results identifying implementation progress including start point, current point and end goal, name of the organization that is the most compliant and the organization least compliant. Finally, provide another story that details the tragic consequences of not wearing a seat belt.

i. Week 9: Informal solutions and peer pressure. (i) Print the informal views and informal recommended solutions to the seat belt problem from employees, unions, employee safety teams, and/or any other employee organization. (ii) Publish a statement that there is no “sitting on the fence”; that each employee must decide to commit to wearing a seat belt—or to commit to not wearing a seat belt. (iii) Publish the performance measure results identifying implementation progress including start point, current point, and end point, and the name of the most compliant and least compliant organizations. (iv) Provide another story that stresses the benefits of wearing a seat belt (v) STOP. Review progress of the performance indicators. If the problem is reduced by 50 percent or more, proceed with Week 10. If the problem is reduced by less than 50 percent, repeat Weeks 6-through 9. Continue repeating until the problem is reduced by 50 percent or more.

j. Week 10: Provide formal solutions. (a) Invite the professionals and management to propose formal views and recommended corrective actions. The corrective actions should include policies and procedures that include aggressive disciplinary action for noncompliance and equally rigorous rewards for compliance. (b) Publish a story that explain the true who, what, when, where, why, and how of seat belts. Define compliance to wearing seat belts and fall implementation of the requirements. (c) Publish the performance measure results identifying implementation progress including start point, current point and end goal, name of the organization that is the most compliant and the organization least compliant. (d) Additionally, provide another story that details the tragic consequences of not wearing a seat belt.

k. Week 11: Inform about formal corrective action. Issue formal management corrective actions emphasizing the informal corrective actions offered by the work force, including any awards, punishments, and incentives. (b) Publish the performance measure results identifying implementation progress including start point, current point and end goal, name of the organization that is the most compliant and the organization least compliant (c) Additionally provide another story that stresses the benefits of wearing a seat belt

1. Week 12: When the compliance goal is achieved, trumpet success. (i) Provide a story that trumpets success upon reaching goals. Recognize individuals by name and pictures. (ii) Publish the performance measure results of meeting the implementation.

m. Week 13: Follow-up. Provide a new edition that contains follow-up awareness information once per month.

n. Week 14: Repeat the process addressing a new topic of information for implementation.

This invention, as described in the Claims, is a series of formula elements that, only when combined in the particular order and using the unique combination that is this invention, serve as the solutions to problems associated to improving implementation of applicable and important information within the work place. Those problems are how to:
a. Assure each employee physically receives each message of information.
b. Assure each employee voluntarily takes the initiative to transfer the knowledge from the information media for the purpose of decoding it, with intent to comprehend its meaning into personal knowledge.
c. Assure each employee is educated on the information and understands what is expected (that the “who, what, where, when, how, and why” questions are comprehended).
d. Gain and maintain the employees' trust in the information and the information source
e. Assure each employee feels a personal knowledge of applicability.
f. Enable each employee to study the information until they understand and retain it for recall.
g. Enable each employee to view the information as applicable to him or herself, personally, and to accept ownership.
h. Enable each employee to be aware of the workgroup's social norms of compliance and taboos of noncompliance.
i. Impose work force and family social pressures on each employee to comply and discourage noncompliance to the requirement.
j. Provide social recognition and rewards for achievement of goals and objectives to implement information and adopt personal behavior in compliance with that information to maintain the desired level of implementation once it has been achieved.

1. A formulated system of improved information, education, and communication to improve the percentage of applicable employees that comply with and implement a new directive and/or existing directives.
a. Subclaim 1(A). The formulated system of claim 1 and incorporating a plurality of periodic information releases displayed at targeted, predetermined locations away from employee workstations, which targeted locations applicable employees will frequent for the purpose of idle and personal time thus optimizing their exposure to the information and their convenience to receiving the information, and by minimizing workstation distractions allowing the study and learning process to be enhanced, such locations predetermined to be where the employees will be idle and bored and thus ensuring the availability of sufficient time to study the information repeatedly to facilitate the retention of knowledge by the employees.
b. Subclaim 1(B). The formulated system of claim 1 in which the content of the periodic information release is (a) edited and styled to be popular with the employees, thus enhancing the employees desire to read, reread and study the information; (b) edited and condensed to limit the amount of information and inconvenience to the employee, thus utilizing the time the employee is at the idle and personal location; (c) edited and designed to limit the amount of knowledge provided to employees at one time to meet the employees' convenience and allowable time to receive the information; and (d) conveyed in the street conversational language of the applicable employees-to aid understanding and knowledge of the requirement by all applicable employees.
c. Subclaim 1(C). The formulated system of claim 1 in which the content of the information is crafted to: (a) affect the employees' compliance so as to inform the applicable employees of the workforce social norms of compliance and taboos of noncompliance, thus promoting informal workforce and informal family-unit social pressures to achieve and maintain compliance to direction; (b) educate the employee on the directive to gain an understanding that answers the questions of who, what, where, when, why, and how to implement the information; (c) gain the employees' belief in the truthfulness of the information release and the source of information; (d) transfer ownership of the information implementation to the employees; (e) provide employees with social rewards for compliance and admonishment for noncompliance with the information to be implemented; and (f) reinforce and maintain implementation once achieved.
